(19) United States
(12) Patent Application Publication
(10) Pub. No.: US 2026/0215613 A1
(43) Pub. Date: Jul. 30, 2026

(54) STEAM WAND FOR FROTHING MILK

(71) Applicant: DE' LONGHI APPLIANCES S.r.l., Treviso (IT)

(72) Inventors: Giovanni ROSSETTO, Treviso (IT); Maurizio CASASOLA, Treviso (IT); Alessandro GANZAROLI, Treviso (IT)

(73) Assignee: DE' LONGHI APPLIANCES S.r.l., Treviso (IT)

(21) Appl. No.: 19/119,395

(22) PCT Filed: Sep. 28, 2023
(86) PCT No.: PCT/EP2023/076853

§ 371 Date: Apr. 8, 2025

(30) Foreign Application Priority Data
Oct. 11, 2022 (CH) 001198/2022
Oct. 11, 2022 (IT) 102022000020973

(51) Int. Cl. A47J 31/44; A47J 31/46

(52) U.S. Cl. CPC A47J 31/4489; A47J 31/461

(57) ABSTRACT

A steam wand for whipping milk or other edible liquids comprises a steam conveyance pipe with a steam delivery nozzle at one end, where the steam delivery nozzle has a non-return valve inside.

### CROSS-REFERENCE TO RELATED APPLICATIONS

This is a U.S. National Phase Application under 35 U.S.C. 371 of International Patent Application No. PCT/EP2023/076853, filed Sep. 28, 2023, which claims benefit of priority to Italian Patent Application No. 102022000020973, filed Oct. 11, 2022, and to Swiss Patent Application No. 001198/2022, filed Oct. 11, 2022. The entire contents of these applications are hereby incorporated by reference.

### FIELD OF THE INVENTION

The present invention relates to a steam wand for whipping milk, which can be connected to a steam generator particularly but not necessarily incorporated in a coffee machine.

### BACKGROUND

As is well known in coffee machines, the steam wand for frothing milk has a steam conveyance pipe with a steam nozzle at one end.

The steam nozzle is intended to be immersed in milk (or similar vegetable drinks) for heating and foaming.

When the steam flow stops, due to a well-known physical principle, a vacuum is created in the steam adduction circuit that tends to suck the milk out.

Sucked milk can flow up through the delivery nozzle and the conveyance pipe to even the steam generator, creating a number of complications such as clogging of the supply circuit, smell of burnt milk and/or unhygienic conditions.

Even the most experienced operator, to avoid this risk, would refrain from pulling the delivery nozzle away from the milk during frothing because the strong jet of steam at a distance from the free milk surface would create dangerous splashes of hot milk and also ruin the quality of the frothing by creating large surface bubbles.

### SUMMARY

To remedy this inconvenience, almost all coffee machine manufacturers have so far provided special shut-off means such as taps, valves, diverters, solenoid valves, positioned in the steam adduction circuit upstream of the steam wand.

This effectively protects the steam generator, but some of the milk is still sucked into the steam wand where it can stagnate for a long time.

Given the high temperatures of the steam flowing in the circuit and taking into account that in any case the milk sucked in at the end of preparation normally exceeds 60° C., it is easy to understand that there is always a high risk that the milk will foul up inside the steam wand and up to the point in the steam adduction circuit where the shutoff devices are located, which are moreover sometimes in parts inside the coffee machine and therefore not accessible.

As a result, problems with the functionality and hygiene of the steam supply circuit may arise overtime.

In the professional world, the bartender's expertise is highly relied upon, and therefore frequent sanitizing/flushing cycles at the end of preparation and/or special cleaning cycles (with special detergents) are required to keep the internal parts of the steam adduction circuit clean.

Such operations often require the supervision of trained personnel (bartenders) and do not always achieve the expected results in a repeatable manner.

The technical task proposed by the present invention is, therefore, to eliminate the technical drawbacks complained of by known steam adduction circuits for milk whipping.

Within the scope of this technical task, one purpose of the invention is to preserve the hygiene and functionality of a steam supply circuit having a wand fitted with a steam nozzle for whipping milk.

Another purpose of the invention is to preserve the hygiene and functionality of such a steam supply circuit in a simple and automatic manner and with repeatable results regardless of the operator's skill.

The technical task, as well as these and other purposes, according to the present invention are achieved by the realization of a steam wand for whipping milk or other edible liquids, comprising a steam conveyance pipe having a steam nozzle at one end thereof, characterized by the fact that said steam nozzle has a non-return valve inside.

In a preferred embodiment of the invention, the said non-return valve comprises a valve body having a steam passage channel having an end for inlet of steam coming from said steam conveyance pipe, an end for outlet of steam and a sealing seat positioned between the steam inlet end and the steam outlet end; a shutter positioned against the sealing seat in the closed position of the steam passage channel and movable to open the steam passage channel by a flow of steam coming from the conveyance pipe; and an elastic element for automatically recalling the shutter in said closed position of the steam passage channel.

In a preferred embodiment of the invention, said valve body comprises a first piece made of a non-stick polymer-based material delimiting a portion of the passage channel extending downstream of the seal seat to the steam outlet end.

In a preferred embodiment of the invention, said valve body includes a second piece of rubber-based material that delimits a portion of the passage channel that includes the seal seat.

In a preferred embodiment of the invention said second piece of rubber-based material delimits a portion of the passage channel extending upstream of the seal seat to the vapor inlet end.

In a preferred mode of embodiment of the invention said second piece is a tubular element extending into an axial cavity of said first piece.

In a preferred embodiment of the invention said second piece has at least one outer perimeter rib which engages tightly with an inner perimeter surface of said first piece.

In a preferred embodiment of the invention said dispensing nozzle comprises a casing for housing said valve body.

In a preferred embodiment of the invention, said second piece has at least one outer perimeter rib which engages tightly with an inner perimeter surface of said casing.

In a preferred mode of embodiment of the invention said nozzle has a connection fitting to said steam conveyance pipe.

In a preferred embodiment of the invention said connection fitting comprises a nipple mechanically connecting said casing to said steam conveying pipe.

In a preferred embodiment of the invention said conveyance pipe comprises an outer pipe and a thermally insulating inner pipe separated by an air gap, and the inner pipe engages the steam passage channel upstream of the sealing seat.

Thanks to the thermally insulating inner pipe, the steam wand in use can be relatively cool to the touch and thus can avoid the danger of scalding by the user and simultaneously burning/burning the milk on contact with external surfaces, even if some of its constituent parts are made of thermally conductive material.

The steam wand for whipping milk can be connected to a steam supply circuit of a coffee machine.

The method for whipping milk thus involves generating steam with a steam generator in the coffee machine and conveying a flow of said steam with a pressure at least sufficient to exert a force on the shutter to open the passage channel that is greater than a predetermined elastic closing force of the passage channel exerted by the elastic element.

Advantageously, therefore, the dispensing nozzle has a non-return valve inside which, when the dispensing nozzle is submerged in milk, blocks the milk from rising and keeps the entire steam supply circuit upstream of the shutter clean.

In order to avoid any kind of fouling, the valve body, in the parts even accidentally wetted by milk, is made of a special polymeric material, e.g. a thermoplastic polymer with anti-adhesion properties.

Additionally, this non-return valve creates a back pressure that stabilizes the flow of delivered steam by calibrating the elastic force to open the passage channel.

Even when the wand is combined with a domestic coffee machine, which generally has an instant steam generator, the quality of the milk frothing is ensured.

In particular, the normally closed non-return valve, thanks to the push of the elastic element, allows the steam wand to be introduced into the liquid to be whipped, blocking any rise of the liquid itself beyond the non-return valve regardless of the depression present inside the steam adduction circuit, which remains completely clean.

When the steam passage is activated, the pressure upstream of the shutter increases until it exceeds the opening value, allowing steam to flow out of the nozzle.

Throughout the heating and foaming phase, the non-return valve remains open, ensuring a defined back pressure and constant flow regardless of the quantity of milk and also, within certain limits, the configuration of the steam output from the delivery nozzle.

When the steam flow is interrupted at the end of the whipping process, the decrease in steam pressure causes the non-return valve to close automatically and prevents hot milk from flowing back into the steam supply circuit.

In addition, the dispensing nozzle can be detached from the steam conveyance pipe for cleaning and inspection by the operator or a technician as a perfect guarantee of correct operation in absolutely hygienic conditions.

### BRIEF DESCRIPTION OF THE DRAWINGS

Further features and advantages of the invention will become more apparent from the description of a non-exclusive embodiment thereof, of the device for frothing milk according to the invention, which is illustrated by way of non-limiting example in the drawings, which:

FIG. 1 shows a schematic view of a coffee machine incorporating the steam wand;

FIG. 2 shows a view of the end of the steam wand;

FIG. 3a shows a longitudinal section of the end of the steam wand with the non-return valve closed due to the uncontained action of the elastic element; and

FIG. 3b shows a longitudinal section of the end part of the steam wand with the non-return valve open due to the opening force exerted on the shutter by the steam flow, which prevails over the closing force exerted on the shutter by the elastic element.

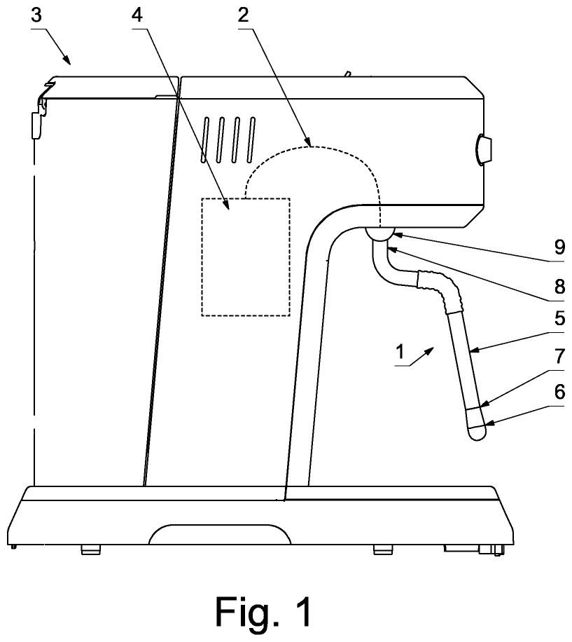

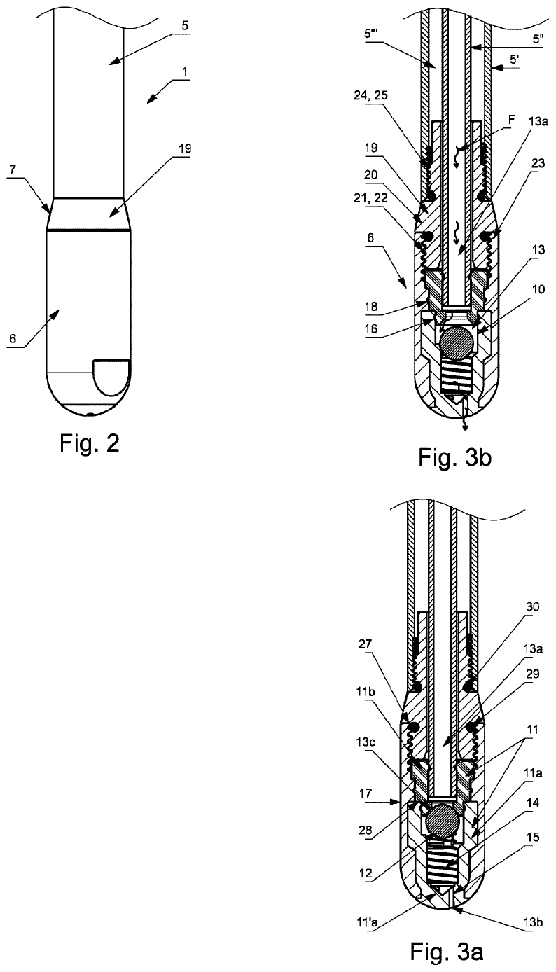

### DETAILED DESCRIPTION

With reference to the above-mentioned figures, a steam wand for whipping milk or other edible liquids is shown, indicated overall by reference number 1.

The steam wand 1 can be connected to a steam adduction circuit 2 that is typically but not necessarily incorporated in a domestic or professional coffee machine 3.

The steam supply circuit 2 may include a steam generator 4 of the accumulator type, particularly if the coffee machine is for professional use, or instantaneous, particularly if the coffee machine is for domestic use.

The steam wand 1 comprises a steam conveyance pipe 5 with a steam nozzle 6 at one end 7, while the other end 8 of the steam conveyance pipe 5 is connected to the steam supply circuit 2. The conveyance pipe 5 of the steam wand 1 can be connected to the steam supply circuit 2 by means of a fixed or preferably articulated joint 9 so that the steam wand 1 can also be orientated during steam supply.

Conveyance pipe 5 comprises an outer pipe 5′ and an inner pipe 5″ separated by an air gap 5″. The inner pipe 5″ is preferably made of a thermal insulation material compatible for use in the food industry, e.g. polytetrafluoroethylene (PTFE) based.

The outer pipe 5′ is typically made of stainless steel. Advantageously, the steam nozzle 6 has a non-return valve 10 inside. The non-return valve 10 comprises a valve body 11 and a shutter 12.

The valve body 11 has a channel 13 for passage of steam coming from the conveyance pipe 5. The steam passage channel 13 has a steam inlet end 13a, a steam outlet end 13b and a seal seat 13c positioned between the steam inlet end 13a and the steam outlet end 13b.

The steam outlet end 13b is formed by one or more calibrated steam outlet holes 15.

The shutter 12 is positioned against the sealing seat 13c in the closed position of the steam passage channel 13 and can be moved to open the steam passage channel 13 by the action of a flow F of steam from the conveyance pipe 5.

The non-return valve 10 has an elastic element 14 to automatically return the shutter 12 to the closed position of the steam passage channel 13.

In the case shown, the shutter 12 is sphere and the elastic element 14 is a coil spring.

The shutter 12 is made of food-compatible material, e.g. polytetrafluoroethylene thermoplastic polymer (PTFE), polyether ether ketone (PEEK), polysulphone (PPS), polyphthalamide (PPA), or polyamide with glass particles (PA+GF).

The elastic element 14 is always made of food-compatible material, e.g. stainless steel.

The valve body 11 comprises a first piece 11a made of a non-stick, and by its nature thermally insulating, polymer-based material compatible for use in the food industry, which delimits a portion of the steam passage channel 13 extending downstream of the seal seat 13c to the steam outlet end 13b.

The polymer-based material may preferably include a thermoplastic polyether ether ketone (PEEK) or thermoplastic polymer polysulphone (PPS), or polyphthalamide (PPA) or glass-particle filled polyamide (PA+GF).

The term ‘downstream’is understood with respect to the direction of steam flow F.

The valve body 11 also includes a second piece 11b of rubber-based material, also compatible for use in the food industry, which delimits a portion of the steam passage channel 13 that includes the seal seat 13c.

The second piece 11b of rubber-based material also delimits a portion of the steam passage channel 13 extending upstream of the seal seat 13c to the steam inlet end 13a.

The term ‘upstream’is understood with respect to the direction of steam flow F.

The rubber used is preferably a silicone rubber or a fluorinated elastomeric rubber (FKM).

More precisely, the second piece 11b is a tubular element that extends into an axial cavity of the first piece 11a.

The second piece 11b has at least one outer perimeter rib 16 that engages tightly with the inner perimeter surface of the first piece 11a.

The first piece 11a accommodates the shutter 12 and the elastic element 14 within its axial cavity which delimits the steam passage channel 13.

The elastic element 14 is axially interposed between the shutter 12 and a front wall 11′a of the first piece I la pierced by the dispensing holes 15.

This same front wall 11′a of the first piece 11a serves, from its inner side, as a support base for the elastic element 14.

In the case shown where the elastic element 14 is a coil spring, the latter is positioned coaxially in the axial cavity of the first piece 11a.

The dispensing nozzle 6 includes a casing 17 housing the valve body 11.

The casing 17 can be made of e.g. stainless steel or thermoplastic polymer suitable for food contact such as polyether ether ketone (PEEK) or polysulphone (PPS), or polyphthalamide (PPA) or glass-filled polyamide (PA+GF).

The second piece 11b has at least one outer perimeter rib 18 that engages tightly with the inner perimeter surface of the casing 17.

The dispensing nozzle 6 has a connection fitting 19 to the steam conveyance pipe 5.

The connection fitting 19 can be made of e.g. stainless steel or glass-filled polyamide (PA+GF). The connection fitting 19 includes a nipple 20 which mechanically connects the casing 17 to the steam conveyance pipe 5.

In the illustrated construction of the dispensing nozzle 6, the second piece 11b is clamped between the first piece 11a and the nipple 20 which in particular has a front male threaded connector 21 engaged in a female threaded connector 22 obtained from a rear extension 23 of the casing 17, and a rear male threaded connector 24 engaged in a female threaded connector 25 obtained from a front end of the steam conveyance conduit 5.

More precisely, the rear male threaded connector 24 of the nipple 20 engages in a female threaded connector 25 formed in the outer pipe 5′ of the steam conveyance pipe 5.

The nipple 20 also has an intermediate flange 27 acting as a screwing end for the rear extension 23 of the casing 17.

Since the first piece 11a and the casing 17 are integral, particularly because they are made by a co-moulding process, at this screwing end position of the rear extension 23 of the casing 17 the rear end of the first piece 11a is axially clamped against an outer side shoulder 28 of the second piece 11b whose rear end in turn is axially clamped against the front male threaded connector 21 of the nipple 20.

The sealing can be completed by suitable gaskets 29, 30 interposed between the nipple 20 and the rear extension 23 of the casing 17, and respectively between the nipple 20 and the steam conveyance pipe 5, particularly the outer pipe 5′.

Advantageously, the inner pipe 5″ of the steam conveyance pipe 5 extends axially beyond the outer pipe 5′ and engages in the inner channel of the connection fitting 19, and in the passage channel 13, particularly in the portion of the passage channel 13 formed in the second piece 11b upstream of the sealing seat 13.

This portion of the passage channel 13 formed in the second piece 11b upstream of the sealing seat 13 has at least one internal perimeter rib 31 of tight engagement with the external perimeter surface of the inner pipe 5″.

Advantageously, the inner pipe 5″ of the pipe 5, since it extends to the inside of the valve body 11 where it seals the second piece 11b of the valve body 11, not only limits the temperature of the wand and nozzle perceived when touched by the operator, but also prevents any milk residue from rising from the passage channel 13 and contaminating the inner surfaces of the casing 17 and the connection fitting 19, thus creating malodorous incrustations on them.

The steam wand, as mentioned, is preferably connected to a coffee machine.

In order to froth milk, steam must be generated with the steam generator in the coffee machine and a flow of said steam F having a pressure at least sufficient to exert on the shutter 12 an opening force of the steam passage channel 13 greater than a predetermined elastic closing force of the steam passage channel 13 exerted by the elastic element 14 must be conveyed along the inner pipe 5″ of the conveyance pipe 5.

The opening thrust exerted by the steam flow F therefore causes the shutter 12, which is opposed by the elastic element 14, to move forward and disengage from the seal seat 13c.

Once the steam flow F is interrupted, its thrust on the shutter 12 is also automatically interrupted, so that the elastic element 14 can automatically return the shutter 12 to the closed position of the steam passage channel 13.

As far as the working range of the elastic element 14 is concerned, it was found to be convenient to set a back pressure range between 0.02 bar and 0.150 bar, where the minimum pressure corresponds to the fully closed position of the shutter 12, i.e. in the absence of steam flow F, and the maximum pressure corresponds to the fully open position of the shutter 12, i.e. the maximum steam flow F.

Conveniently, the operator can inspect the steam wand before or after use and clean it by disconnecting nozzle 6 from steam conveyance pipe 5.

The wand for whipping milk or other edible liquids thus conceived is susceptible to numerous modifications and variations, all within the scope of the inventive concept; moreover, all details are replaceable by technically equivalent elements.

In practice, the materials used, as well as the dimensions, can be any according to requirements and the state of the art.

1. A steam wand for whipping milk or other edible liquids, comprising a steam conveyance pipe having a steam dispensing nozzle at one end, wherein the steam dispensing nozzle has a non-return valve inside.

2. The steam wand for whipping milk according to claim 1, wherein said non-return valve comprises a valve body having a steam passage channel having a steam inlet end for an inlet of steam coming from said steam conveyance pipe, a steam outlet end for an outlet of steam and a sealing seat positioned between the steam inlet end and the steam outlet end; a shutter positioned against the sealing seat in a closed position of the steam passage channel and movable to open the steam passage channel by a flow of steam coming from the conveyance pipe; and an elastic element for automatically recalling the shutter in said closed position of the steam passage channel.

3. The steam wand for whipping milk according to claim 2, wherein said valve body comprises a first piece made of a non-stick, thermally insulating polymer-based material which delimits a portion of the steam passage channel extending downstream of the seal seat to the steam outlet end.

4. The steam wand for whipping milk according to claim 3, wherein said valve body includes a second piece of rubber-based material delimiting a portion of the steam passage channel which includes the seal seat.

5. The steam wand for whipping milk according to claim 4, wherein said second piece delimits a portion of the steam passage channel extending upstream of the seal seat to the steam inlet end.

6. The steam wand for whipping milk according to claim 4, wherein said second piece is a tubular element extending into an axial cavity of said first piece.

7. The steam wand for whipping milk according to claim 4, wherein said second piece has at least one outer perimeter rib which engages tightly with an inner perimeter surface of said first piece.

8. The steam wand for whipping milk according to claim 2, wherein said shutter is a sphere and said elastic element is a coil spring.

9. The steam wand for whipping milk according to claim 4, wherein said steam dispensing nozzle comprises a casing for housing said valve body.

10. The steam wand for whipping milk according to claim 9, wherein said second piece has at least one outer perimeter rib which engages tightly with an inner perimeter surface of said casing.

11. The steam wand for whipping milk according to claim 9, wherein said steam dispensing nozzle has a connection fitting to the conveyance pipe.

12. The steam wand for whipping milk according to claim 11, wherein said connection fitting comprises a nipple mechanically connecting said casing to said steam conveyance pipe.

13. The steam wand for whipping milk according to claim 11, wherein said steam conveyance pipe comprises an outer pipe and an inner pipe separated by an air gap, and the inner pipe sealingly engages in the steam passage channel upstream of the sealing seat.

14. A coffee machine with a steam wand for frothing milk, the steam wand comprising:
a steam conveyance pipe having a steam dispensing nozzle at one end, wherein the steam dispensing nozzle has a non-return valve inside.

15. A method for whipping milk with a coffee machine with a steam wand the steam wand comprising:
a steam conveyance pipe having a steam dispensing nozzle at one end, wherein the steam dispensing nozzle has a non-return valve inside, said non-return valve comprises a valve body having a steam passage channel having a steam inlet end for an inlet of steam coming from said steam conveyance pipe, a steam outlet end for an outlet of steam and a sealing seat positioned between the steam inlet end and the steam outlet end; a shutter positioned against the sealing seat in a closed position of the steam passage channel and movable to open the steam passage channel by a flow of steam coming from the conveyance pipe; and an elastic element for automatically recalling the shutter in said closed position of the steam passage channel;
the method comprising:
generating steam with a steam generator present in the coffee machine and conveying along said steam conveyance pipe the flow of steam having a pressure at least sufficient to exert on the shutter an opening force of the steam passage channel greater than a predetermined elastic force to close the steam passage channel exerted by the elastic element.
